(19) United States
(12) Patent Application Publication
(10) Pub. No.: US 2025/0326410 A1
(43) Pub. Date: Oct. 23, 2025

(54) SYSTEMS AND METHODS FOR PORTABLE AND AUTONOMOUS RAILROAD TRACK MEASUREMENT

(71) Applicant: Holland, L.P., Crete, IL (US)

(72) Inventors: Sabri Cakdi, Naperville, IL (US); Corey Hart, Schererville, IN (US); Thomas Wayne Dodgen, Irmo, SC (US); Erik Curran, Lake Forest, IL (US); Engin Caglav, Izmir (TR); Umit Kayacik, Izmir (TR); Volkan Sigali, Izmir (TR)

(21) Appl. No.: 19/061,265

(22) Filed: Feb. 24, 2025

Related U.S. Application Data
(60) Provisional application No. 63/557,164, filed on Feb. 23, 2024.

(51) Int. Cl. B61K 9/08; B61L 25/02; G01B 11/24; G01S 13/60

(52) U.S. Cl. CPC B61K 9/08; B61L 25/021; G01B 11/24; G01S 13/60

(57) ABSTRACT

Systems and methods for portable and autonomous advanced rail track measurement provide contactless railroad geometry and rail profile measurement deployable on any railway via hybrid highway-rail (“hi-rail”) vehicles and/or locomotives, utilizing an embedded FPGA (Field-Programmable Gate Array)-based hardware architecture design. This innovative system calculates all track geometry parameters and generates rail profiles directly on the hardware, eliminating the need for external computing resources.

### CROSS-REFERENCE TO RELATED APPLICATIONS

The present invention claims priority to U.S. Prov. Pat. App. No. 63/557,164, titled “Systems and Methods for Portable and Autonomous Railroad Track Measurement,” filed Feb. 23, 2024, which is incorporated herein by reference in its entirety.

### TECHNICAL FIELD

The present invention relates to systems and methods for portable and autonomous rail track measurement. Specifically, rail track measurement systems provide contactless railroad geometry and rail profile measurement deployable on any railway via hybrid highway-rail (“hi-rail”) vehicles and/or locomotives.

### BACKGROUND

Railroad tracks provide and have provided an important means for moving goods and people from one location to another both in this country and throughout the world for many years. Due to the nature of steel wheels of locomotives and railcars rolling on steel rails, trains offer three to four times more fuel or energy efficient transportation compared to rubber tires on asphalt of roadway vehicles. A single freight or passenger train replaces hundreds of trucks or automobiles, resulting in the reduction of highway congestion and lower greenhouse gas emissions. While freight trains haul essential raw and finished goods for a resilient and functioning economy, passenger trains offer oftentimes faster and more convenient transportation to millions of travelers, such as commuters in urban areas, especially during times of high highway congestion.

The great advantages offered by rail travel, however, come with unique operations and maintenance challenges. A railroad track, composed of a pair of parallel rails, fasteners, ties, ballast and substructure, deviates from its original design state over time due to operational loads and weather conditions.

Thus, measuring the position of track center, horizontal distance between rails, and each rail's position in three-dimensional space (known as “track geometry”) is an essential part of railroad track inspection and maintenance planning. Regulation agencies, such as the Federal Railroad Administration (FRA) of the United States, provides track geometry definitions, standards, and deviation thresholds (often referred to as “geometry defects” or “geometry deviations”), and speed limits, among others, as part of track safety standards. If these defects/deviations are not measured and detected timely, train derailments can occur. According to the FRA, there were 134 reported train derailments in the United States in 2022 due to track geometry failures.

Despite some differences among countries, fundamental track geometry measurements including the following:

Track Gauge: The horizontal distance between two rails measured from the gauge point, which is the hypothetical point where the wheel flange contacts.

Crosslevel: The height difference between the two rails measured at the highest point of each rail head.

Degree of curvature: Horizontal rate of change of track centerline by design.

Surface: Vertical position of track centerline or each rail over a distance.

Alignment: Horizontal position of track centerline or each rail over a distance.

Modern track geometry systems typically generate these measurements, along with additional customized measurements, to locate areas where measurements exceed safety thresholds to prevent potential derailments and identify areas requiring maintenance.

Historically, track geometry was measured with remarkably simple tools, such as tape measures, bubble levels, ropes or strings cut to specific lengths, etc. After the development of modern sensor technologies, such as accelerometers, gyroscopes, and displacement transducers, the variety of track geometry measurement concepts has greatly developed over the last hundred years. Today, there are, generally, two types of track geometry measurement concepts: “absolute” and “relative.”

An absolute track geometry system utilizes a fixed reference point on earth and maps out the position of each rail and track centerline with respect to that reference point, typically measured from a pushcart trolley type platform. This technique is often used for track construction verification or spot checks since it is typically limited by walking speed.

A relative track geometry system typically deploys from a vehicle rolling on the track. The reference point is the center of the track, and the system moves with the vehicle. To assess the track from a vehicle perspective and cover large areas of network, track safety standards are built around relative geometry systems. Early versions of modern relative geometry systems utilized spring-loaded mechanical rollers that touched both rails at each gauge point, where, theoretically, railway wheel flanges touch. Track gauge is then recorded via displacement transducers. In addition, gyroscopes, accelerometers, and/or railway wheel-mounted displacement transducers have been used to create vertical and horizontal position of track and rails. This version of modern relative track geometry systems is known as “mechanical gauge” or “contact-based” systems. These systems have serious maintenance and accuracy problems because contact-based rollers tend to wear out or break frequently and sometimes limit measurement speed. Mechanical or contact-based relative track geometry systems have been replaced by a non-contact concept recently, typically using some form of laser and/or camera technologies to identify and measure gauge and top point of rails and utilize inertial or displacement transducers like mechanical systems. State of the art non-contact relative track geometry systems eliminate the mechanical and reliability issues of previous generation mechanical systems and have resulted in significant enhancement of accuracy and repeatability.

Modern railroad track geometry measurement systems, as explained above, heavily rely on railway wheel-mounted encoders, generating high resolution distance output by converting wheel rotation angle to linear displacement, thereby measuring distance. Like mechanical systems, wheel-mounted encoders also suffer from reliability and accuracy issues.

First, railway wheels are exposed to excessive shocks and vibrations frequently. For example, railway wheels can be exposed to shocks and vibrations more than 100 times gravity (“100 g”) due to vertical weak spots and rail discontinuities at special trackwork, such as at rail joint gaps, frogs at turnouts, and/or diamond crossings.

Second, wheel-mounted encoders rely on accurate wheel diameter input to convert angular wheel rotation to linear distance. Railway wheels are designed to be conical for steering and wheel diameter heavily depends on where the wheel contacts the rail. Thus, if the wheels contact the rail at various locations, measurements will be inaccurate.

Third, railway wheels wear out over time causing the wheel diameters to reduce. This adds additional inaccuracies to wheel-mounted encoder-based distance measurements.

Fourth, powered axles may cause wheels to develop micro-slippage while rolling on rails, typically by design to operate at optimum adhesion and traction. Wheel micro-slippage further contributes to inaccurate measurements.

Current track geometry systems are mounted either directly on a railcar or on a platform attached to a hi-rail vehicle. However, mounting a track geometry measuring system onto a hi-rail vehicle is often difficult, expensive, and time consuming. Moreover, track geometry measuring systems typically have special power requirements that may be difficult to satisfy when mounted on dual mode vehicles known as hi-rail vehicles that can operate both on highways and on railroad tracks.

Other known track geometry systems are typically mounted on vehicles or on railcars that fail to provide accurate track geometry problems, especially regarding vertical deflection of railroad tracks when a train passes thereover, which may be caused by inadequate support of tracks or other structural issues. For example, known track geometry systems are mounted on railcars, which are typically not the heaviest elements of a train.

A need, therefore, exists for improved systems and methods for measuring railroad track geometry. Specifically, a need exists for improved systems and methods that accurately and reliably provide track geometry measurements. More specifically, a need for improved systems and methods that better identify non-compliant locations of railroad tracks relative to rail profile regulations and standards. In addition, a need exists for improved systems and methods for measuring track geometry that is non-invasive and non-contact, so that measurements are unaffected by wear out of train elements.

Current track geometry systems are mounted either directly on a railcar or on a platform attached to a hi-rail vehicle. However, mounting a track geometry measuring system onto a hi-rail vehicle is often difficult, expensive, and time consuming. Moreover, track geometry measuring systems typically have special power requirements that may be difficult to satisfy when mounted on a hi-rail vehicle.

A need, therefore, exists for improved systems and methods for measuring railroad track geometry that may be easily mounted on a hi-rail truck. Specifically, a need exists for improved systems and methods for measuring railroad track geometry that is mounted on a hi-rail standard hitch assembly. Moreover, a need exists for improved systems and methods for measuring railroad track geometry that is made compact by manipulating the same for storage, shipment, and/or for ease of use.

Other known track geometry systems are typically mounted on vehicles or on railcars that fail to provide accurate track geometry problems, especially regarding vertical deflection of railroad tracks when a train passes thereover, which may be caused by inadequate support of tracks or other structural issues. For example, known track geometry systems are mounted on railcars, which are typically not the heaviest elements of a train.

A need, therefore, exists for improved systems and methods for measuring railroad track geometry that more accurately reflects certain measured parameters, such as, for example, vertical displacement of track as a train passes thereover. Specifically, a need exists for improved systems and methods for measuring railroad track geometry that is mounted to a locomotive, the heaviest element of a train and that causes the most vertical deflection. More specifically, a need exists for improved systems and methods for measuring railroad track geometry that is mounted in alignment with locomotive wheels, thereby maximizing the vertical displacement as a train passes thereover.

### SUMMARY OF THE INVENTION

The present invention relates to systems and methods for portable and autonomous rail track measurement. Specifically, rail track measurement systems provide contactless railroad geometry and rail profile measurement deployable on any railway via hybrid highway-rail (“hi-rail”) vehicles and/or locomotives.

To this end, in an embodiment of the present invention, a system of measuring track rail geometry is provided. The system comprises a frame comprising one or more track geometry measurement sensors, wherein the frame comprises a rotatable arm and a hitch bar extending from the rotatable arm, wherein the rotatable arm is configured to rotate the frame from a horizontal configuration to a vertical configuration when the high bar extending from the rotatable arm is rigidly held within a hitch receiver tube disposed on a hi-rail vehicle.

In an alternate embodiment of the present invention, a system of measuring track rail geometry is provided. The system comprises a hanger bracket extending from an L-bracket, wherein a track rail measurement system is disposed on the hanger bracket, wherein the track rail measurement system comprises one or more track rail geometry measurement sensors, and further wherein at least one shock spring connects the trail rail measurement system to the hanger bracket.

In yet another alternate embodiment of the present invention, a system for measuring distance and/or velocity of a locomotive or a hi-rail vehicle is provided. The system comprises a dual radar module having a first antenna and a second antenna, wherein the first and second antennas are disposed in a V-configuration, wherein the dual radar module is configured to be placed on a locomotive or a hi-rail vehicle in a location near a pair of parallel track rails.

It is, therefore, an advantage and objective of the present invention to provide improved systems and methods for measuring railroad track geometry.

Specifically, it is an advantage and objective of the present invention to provide improved systems and methods that accurately and reliably provide track geometry measurements.

More specifically, it is an advantage and objective of the present invention to provide improved systems and methods that better identify non-compliant locations of railroad tracks relative to rail profile regulations and standards.

In addition, it is an advantage and objective of the present invention to provide improved systems and methods for measuring track geometry that is non-invasive and non-contact, so that measurements are unaffected by wear out of train elements.

Moreover, it is an advantage and objective of the present invention to provide improved systems and methods for measuring railroad track geometry that may be easily mounted on a hi-rail truck.

Specifically, it is an advantage and objective of the present invention to provide improved systems and methods for measuring railroad track geometry that is mounted on a hi-rail standard hitch assembly.

Moreover, it is an advantage and objective of the present invention to provide improved systems and methods for measuring railroad track geometry that is made compact by manipulating the same for storage, shipment, and/or for ease of use.

Further, it is an advantage and objective of the present invention to provide improved systems and methods for measuring railroad track geometry that more accurately reflects certain measured parameters, such as, for example, vertical displacement of track as a train passes thereover.

Specifically, it is an advantage and objective of the present invention to provide improved systems and methods for measuring railroad track geometry that is mounted to a locomotive, the heaviest element of a train and that causes the most vertical deflection.

More specifically, it is an advantage and objective of the present invention to provide improved systems and methods for measuring railroad track geometry that is mounted in alignment with locomotive wheels, thereby maximizing the vertical displacement as a train passes thereover.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A-1C illustrate a portable hi-rail hitch-mounted track measurement system in embodiments of the present invention.

FIGS. 2A-2B illustrate a dual doppler radar unit incorporated into the track measurement systems in an embodiment of the present invention.

FIG. 3 illustrates an exemplary architecture of a hi-rail sensor configuration system in an embodiment of the present invention.

FIG. 4 illustrates a portable hi-rail hitch-mounted track measurement system mounted in a deployed configuration to a hi-rail vehicle in an embodiment of the present invention.

FIG. 5 illustrates a portable hi-rail hitch-mounted track measurement system mounted in a stored configuration to a hi-rail vehicle in an embodiment of the present invention.

FIG. 6 illustrates a schematic of a portable hi-rail hitch-mounted track measurement system in an embodiment of the present invention.

FIG. 7 illustrates a schematic of a locomotive track rail geometry system for measuring track rail geometry in an embodiment of the present invention.

FIG. 8 illustrates a track rail measurement bracket system for disposing a rail measurement system to a truck of a locomotive in an embodiment of the present invention.

FIG. 9 illustrates a track rail measurement system disposed on a track rail measurement bracket system in an embodiment of the present invention.

FIG. 10 illustrates an exemplary power conversion and communication hardware architecture in an embodiment of the present invention.

FIG. 11 illustrates a two rail sensor configuration system in an embodiment of the present invention.

FIG. 12 illustrates a two rail sensor configuration system and rail profile measurements generated thereby in an embodiment of the present invention.

FIG. 13 illustrates an exemplary two rail sensor configuration system hardware architecture in an embodiment of the present invention.

FIG. 14 illustrates a four rail sensor configuration system in an embodiment of the present invention.

FIG. 15 illustrates a four rail sensor configuration system and rail profile measurements generated thereby in an embodiment of the present invention.

FIG. 16 illustrates an exemplary four rail sensor configuration system hardware architecture in an embodiment of the present invention.

FIG. 17 illustrates an exemplary two rail or four rail sensor configuration system architecture in an embodiment of the present invention.

### DETAILED DESCRIPTION OF THE PRESENTLY PREFERRED EMBODIMENTS

The present invention relates to systems and methods for portable and autonomous rail track measurement. Specifically, rail track measurement systems provide contactless railroad geometry and rail profile measurement deployable on any railway via hybrid highway-rail (“hi-rail”) vehicles and/or locomotives.

### HI-Rail Sensor Configuration

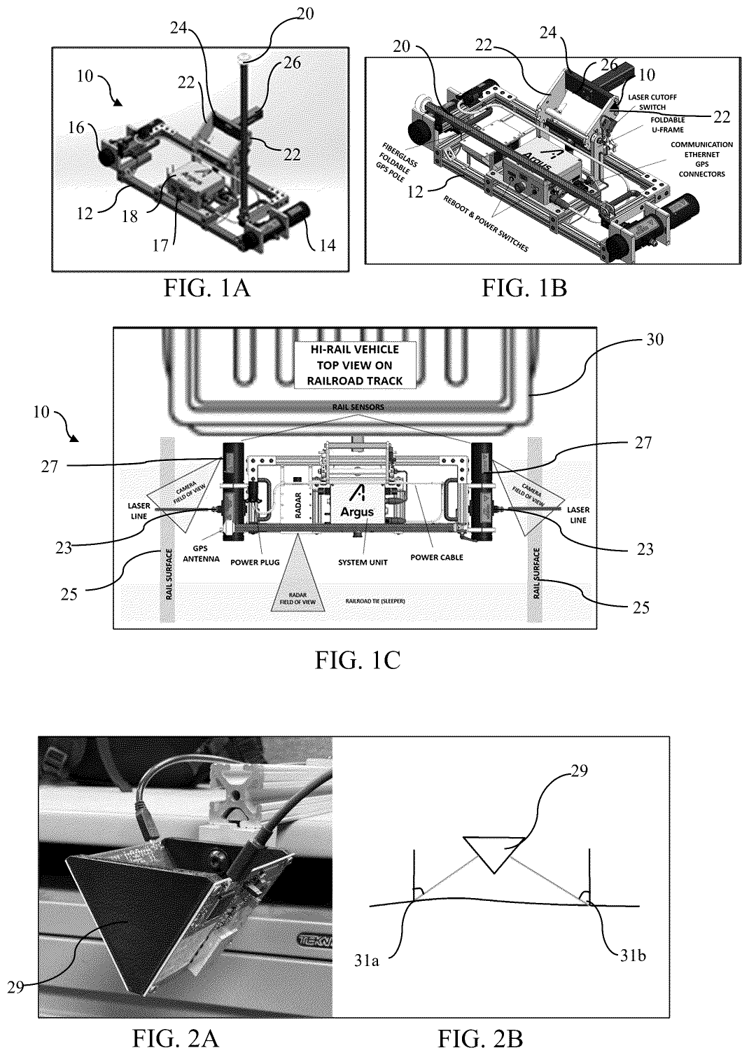

Referring now to FIG. 1, in an embodiment of the present invention, a portable hi-rail hitch-mounted track measurement system 10 (“system 10”) is provided. The system 10 generally comprises a frame 12 on which the various components thereof are mounted, as described in more detail below. The system may be removably mounted on a hi-rail vehicle 30, as illustrated in FIG. 4.

Moreover, the system 10 comprises first and second rail sensors 14, 16 disposed on and mounted to opposite sides of the frame 12, generally configured to be in alignment with parallel rails of a railroad track when used thereon. The first and second rail sensors 14, 16 may preferably utilize lasers that may be detectable via one or more optical sensors or cameras that may be utilized to accurately measure track geometry of the parallel rails, as further illustrated in FIG. 1C, which shows an overhead view of the system 10. Specifically, extending on opposite sides of the frame 12 may be a pair of laser modules 23 that may send a laser beam outwardly and toward the parallel rail surfaces 25 and back to detect aberrations on the parallel rail surfaces 25. A pair of cameras 27 may further be positioned and aimed toward the parallel rail surfaces 25 for recording visual aberrations that may be detected on the rail surfaces 25, which may be viewed by human and/or computer detection systems.

In addition, a laser safety switch 17 may further extend from the frame 12 that may be used for detecting emergency situations to shut down the system 10, if necessary. Of course, any other component for measuring track geometry or for measuring any other desired parameter may be provided on the frame 12, such as, for example, one or more cameras, infrared devices, one or more radar units, as described below, lidar units, optical units, or any other component for measuring any aspect of railroad tracks, such as geometry or the like.

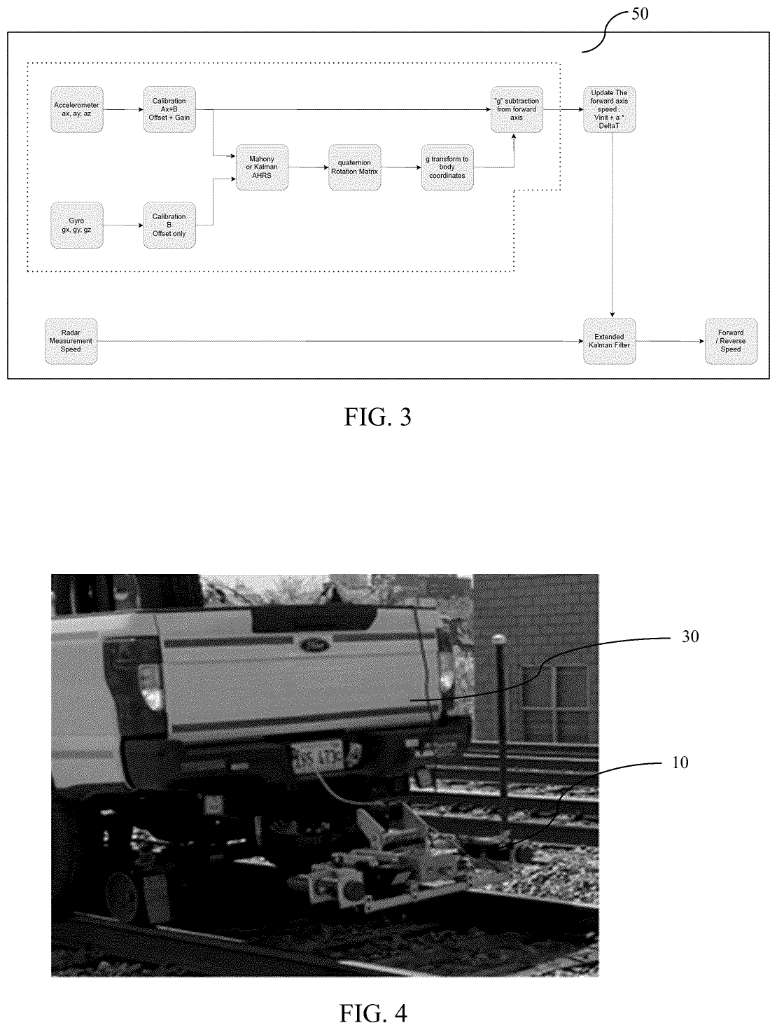

For example, as illustrated in FIGS. 2A-2B and 3, a doppler radar system 29 may be utilized having a housing in a V-shaped geometry such that radar elements may be disposed on the angled surfaces so as to be aligned in a proper configuration to measure a location position 31a in front of and a location position 31b behind the radar system 29 (as illustrated in FIG. 2B) for measuring, for example, velocity, direction, and distance. Other components may further be incorporated therein, including, for example, an inertial measurement unit which may comprise one or more accelerometers and one or more gyroscopes for measuring movement of the same which may be caused by aberrations and damage to rail surfaces. FIG. 3 illustrates an exemplary architecture 50 of doppler radar infused with accelerometers and gyroscopes for generating data for distance, directional, velocity, and other like properties, such as those noted above. The radar signals and other data generated thereby and measured may utilize high frequency sampling and may be processed and converted into formats that may be readily utilized by inspection systems, such as by using signal filters and the like.

Referring again to FIGS. 1A-1B, the system 10 may further comprise a system processing unit 18 mounted on the frame 12, generally in a central location of the frame 12, and mounted in a sturdy, rigid, and robust manner to protect the same from vibrations during use thereof. An antenna 20 may be mounted to the frame 12 and may further have a hinge or rotating mechanism at the base thereof to allow the antenna 20 to lay down horizontally, as shown in FIG. 1B, such as, for example, for stowing and/or storage. Further, the antenna 20 may allow the system processing unit 18 and any other component disposed on the frame or within the hi-rail vehicle to communicate with another system. For example, data compiled by the system 10 may be transmitted via the antenna to another location while the hi-rail vehicle 30 having the system 10 thereon is in the field measuring track geometry. Alternately, information may be transmitted to the antenna 20 for reception thereby. Finally, the antenna 20 may be associated with a location detection means, such as a GPS device for accurate location detection when the hi-rail vehicle 30 is measuring track geometry parameters. Alternately, a separate GPS antenna may be provided for such a purpose.

A pair of rotating arms 22 may extend from a rear of the frame 12 that may be connected by a bridging member 24 having a trailer hitch bar 26 extending rearwardly therefrom. The trailer hitch bar 26 may allow the frame and components associated therewith to be held within a trailer hitch receiver tube on a hi-rail vehicle 30, as illustrated in FIG. 2. Moreover, the system 10 may be powered using a conventional hitch power outlet, such as, for example, a standard 4-pin or 7-pin hitch outlet.

The rotating arms extending from the rear of the frame 12 may allow the frame 12 to rotate upwardly when the trailer hitch bar 26 is rigidly held within the trailer hitch receiver tube on the hi-rail vehicle 30, as illustrated in FIG. 4. Thus, the frame 12 and various components thereon may rotate from a horizontal configuration to a vertical configuration and may be held in place using a pin/slot configuration or any other mechanism apparent to one of ordinary skill in the art. Of course, the antenna 20 may be in a down and horizontal configuration prior to rotation of the frame 12 so as not to impact the hi-rail vehicle 30 when rotated.

FIG. 6 illustrates a schematic of the system 10 in an embodiment of the present invention, including the frame 12, the first and second rail sensors 14, 16, the laser unit 17, the system processing unit 18, and various other components. In addition to these components, a GPS antenna 32 may be provided for receiving GPS signals for location detection. In addition, a radar unit 34 may be utilized for driving and controlling the first and second rail sensors 14, 16 having, for example, the laser modules 23 and cameras 27, for track geometry measurements.

The hi-rail vehicle 30 may further have additional components of the system 10, such as, for example, a control computing device 36, a power inverter 38 for powering the same and other components within the hi-rail vehicle 30, such as, for example, a network switch 40, a cellular modem, router, and Wi-Fi unit 42, and other like components that may be necessary for driving and/or controlling the system 10. For example, a wireless table 44 may be utilized for recording events during the track geometry measurements, which may be recorded for follow-up review and analysis.

To aid in accurate and robust track geometry measurements, one or more inertial measurement units (IMUs) may be deployed to filter noise which may be caused by vibrations, bumps, impacts, shocks, strikes, or other like noise. In a preferred embodiment, the IMUs of the present invention obtain noise information by measuring, in real time, the amount of noise generated during a track measurement operation. The IMU further, in real time, applies the noise measurements to the data received from the other track geometry sensors to filter out the noise from the track geometry measurements.

The information gathered by the system 10, as described herein, may be compiled, transmitted, analyzed, and used by receivers thereof. Preferably, the information may be presented to a user in a simple-to-use graphic user interface (GUI) allowing for ease of viewing and review.

### Locomotive Sensor Configuration

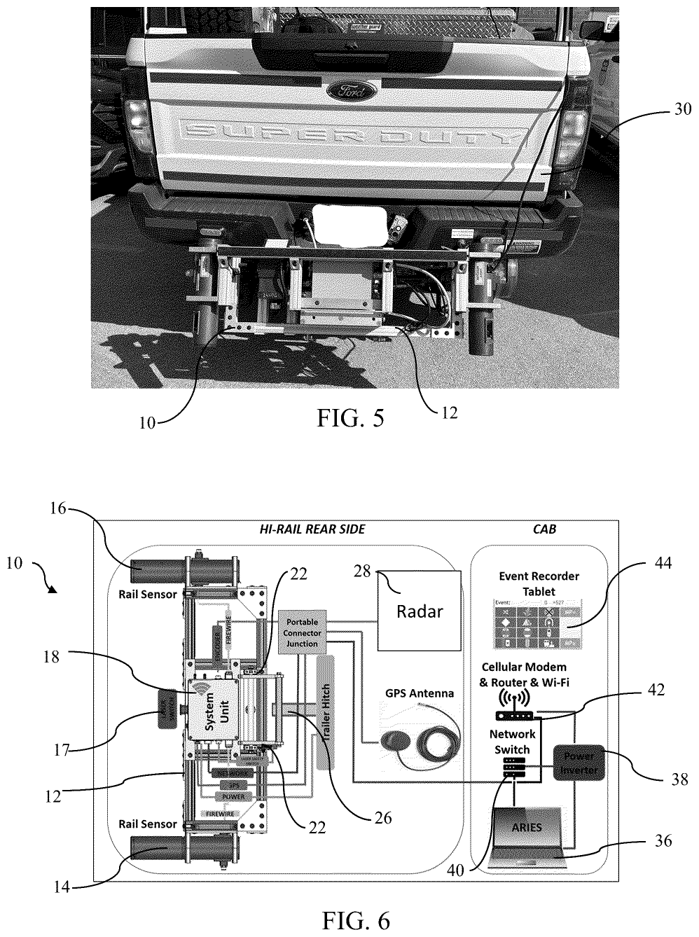

In addition to portable track measurements conducted by the system 10, described in detail above, a locomotive geometry measurement system 100, otherwise known as an “unattended geometry measurement system (“UGMS”), may be utilized on locomotives to further provide accurate measurements. Many track geometry conditions become measurable only when heavy rail units roll thereon. Locomotives typically are the heaviest parts of a train and so incorporating a track geometry measurement system therein may offer additional advantages. As illustrated in FIG. 5, the locomotive geometry measurement system 100 may comprise several components, including a track rail measurement system 102 disposed on a truck of the locomotive, a radar unit 104 and/or an emergency stop unit 106 on a body of the locomotive, a power conversion and communication box 108, which may be tied directly to a locomotive electrical panel 110, within a cab of the locomotive, and a GPS antenna 112, a cellular antenna 114, or any other antenna apparent to one of ordinary skill in the art.

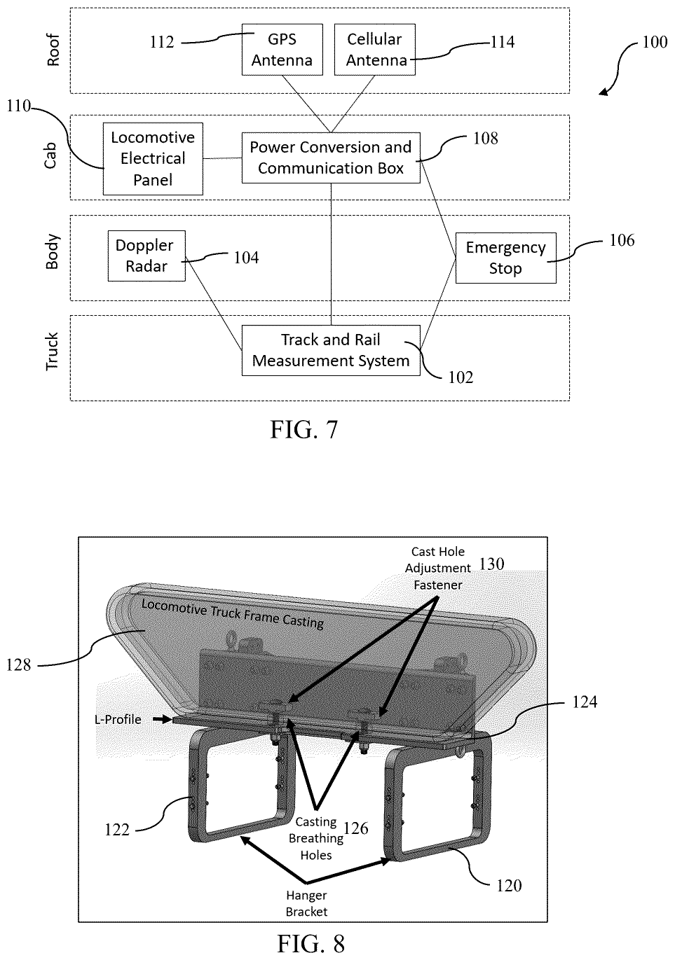

The track rail measurement system 102 may be disposed on the truck of the locomotive as shown in FIGS. 6 and 7. Specifically, first and second hanger brackets 120, 122 may extend from a reinforced L-bracket 124 that may be rigidly attached through casting breathing holes 126 within an existing locomotive truck frame casting 128 via cast hole adjustment fasteners 130. The track rail measurement system 102 may be mounted to the first and second hanger brackets 120, 122 as illustrated in FIG. 7. Therefore, the first and second hanger brackets 120, 122 may be aligned between two sets of locomotive wheels, preferably beneath or near the cab of the locomotive.

As illustrated in FIG. 7, the track rail measurement system 102 may be tied to the first and second hanger brackets 120, 122, and may be connected thereto via shock mounting springs 140a, 140b, 140c, 140d. The shock mounting springs 140a-140d may be utilized to protect the track rail measurement system 102 by dampening vibrations as the locomotive rolls on track rails. In addition, the movement of the shock mounting springs 140a-140d may filter low frequency noise that may not be indicative of significant track issues. However, significant issues with track geometry may be registered as significant movement of the shock mounting springs 140a-140d and may be detected by the track rail measurement system 102. Therefore, insignificant track geometry issues may not be registered, whereas significant track geometry issues that may cause high excitation of the shock mounting springs 140a-140d may be detected.

The system 100 may include the same or similar components as described above with respect to the system 10. Specifically, the track rail measurement system 102 may comprise first and second rail sensors 144, 146 disposed on and mounted to opposite sides of the track rail measurement system 102, generally configured to be in alignment with parallel rails of a railroad track when used thereon. The first and second rail sensors 144, 146 may preferably utilize lasers that may be detectable via one or more optical sensors and/or cameras that may be utilized to accurately measure track geometry of the parallel rails. Of course, any other component for measuring track geometry or for measuring any other desired parameter may be provided thereon, such as, for example, one or more cameras, infrared devices, one or more radar units, as described below, lidar units, optical units, or any other component for measuring any aspect of railroad tracks, such as geometry or the like.

The radar unit 104 may preferably be utilized to provide non-contact distance and/or velocity measurements for use in the system 100 disclosed herein, which may be necessary to locate and generate measurements accurately. Specifically, dual doppler radar may be used to make highly accurate distance and/or velocity measurement as the system 100 conducts track geometry measurements using the locomotive. Specifically, the dual doppler radar sensors may be positioned in a V-shape and at an optimum angle to make the measurements. As noted above with respect to FIGS. 2A-2B and 3, other sensors, such as accelerometers, gyroscopes, and other like sensors, may be utilized for generating other inertial data. The radar signals and other data generated thereby and measured may utilize high frequency sampling and may be processed and converted into formats that may be readily utilized by inspection systems, such as by using signal filters and the like.

The emergency stop unit or units 106 may utilize laser safety switches to provide an emergency shut down of the locomotive geometry measurement system 100 if an emergency presents itself, such as an event that may be detectable by the laser units 106.

The power conversion and communication box 108 may utilize power from the locomotive electrical panel 110 and convert the same for use with the system 100, described herein. Preferably, the system 100 operates at either or both of 12 VDC or 24 VDC, or any other voltage or power level and should not be limited as described herein. The power conversion and communication box 108 may further have communication modules therein, such as for receiving GPS data using the GPS antenna 112 and/or for communicating with other systems for transmitting data and/or receiving data or instructions using the cellular antenna 114. FIG. 10 illustrates an exemplary locomotive based autonomous system power and communication panel architecture 150, in an embodiment of the present invention.

### Optional Rail Sensor Configurations

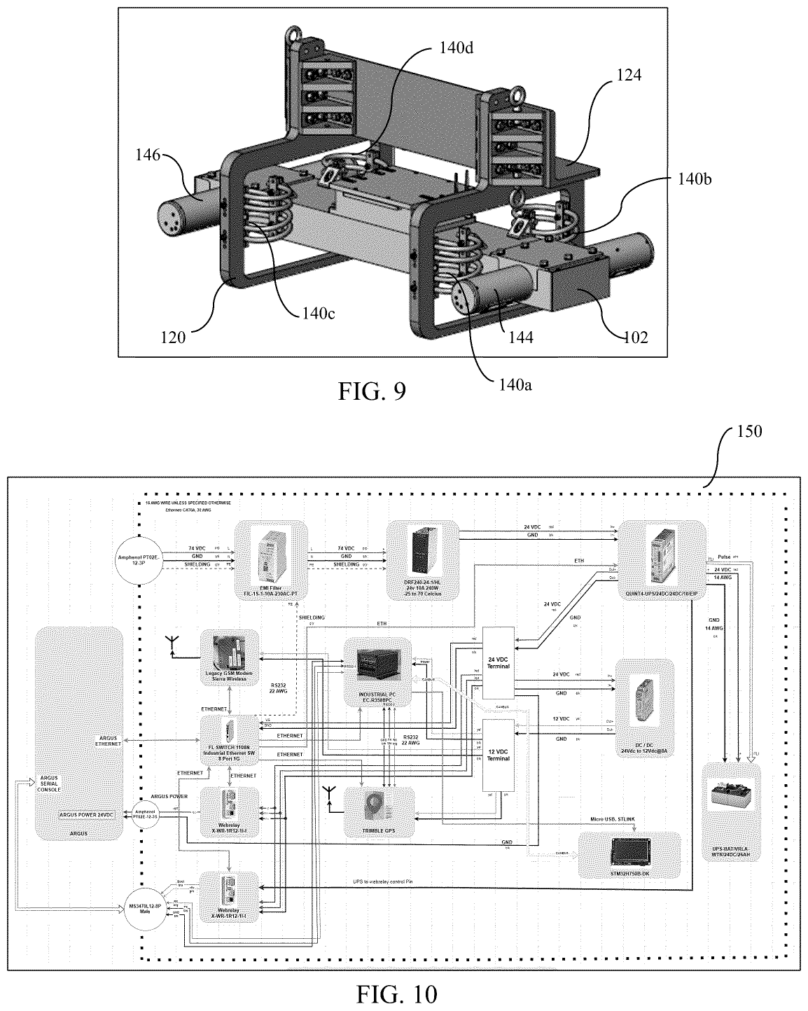

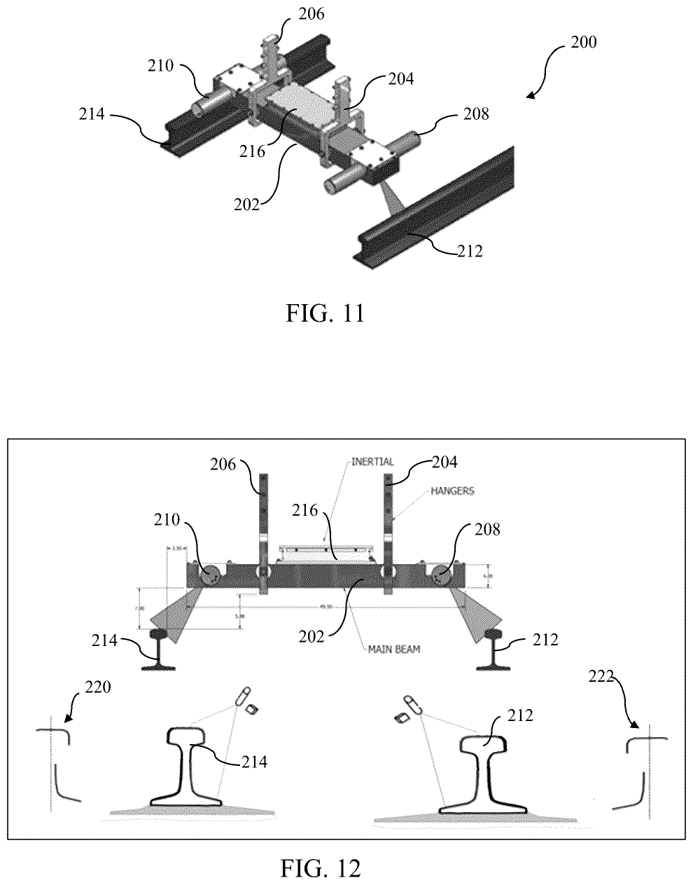

The systems 10 and 100, described above, and illustrated with respect to FIGS. 1-10 illustrate exemplary rail sensor configurations. Optionally, the systems 10, 100 may further include other track geometry and rail profile sensors, as described herein and shown in FIGS. 11-17.

Specifically, FIGS. 11-13 illustrates an alternate two-rail sensor configuration system 200 in an embodiment of the present invention, which is similar to the sensor configurations described above, especially in configuration systems 10 with respect to the hi-rail sensor configuration and 100 with respect to the locomotive sensor configuration. As illustrated, a main beam 202 may be rigidly attached to frame brackets 204, 206 (or a frame in a hi-rail application, described above). A pair of removable and rotational laser optic sensors 208, 210 may extend on opposite sides of the main beam 202 for measuring, via lasers and cameras, as described herein, the geometries and/or the surfaces of rails 212, 214. A control box 216 may contain additional sensors, such as inertial sensors including, for example, accelerometers and gyroscopes for additional inertial data. As illustrated in FIG. 12, the laser-optic sensors 208, 210 may obtain, generally, inside profiles of rail track geometries and surfaces, shown by the outlines 220, 222.

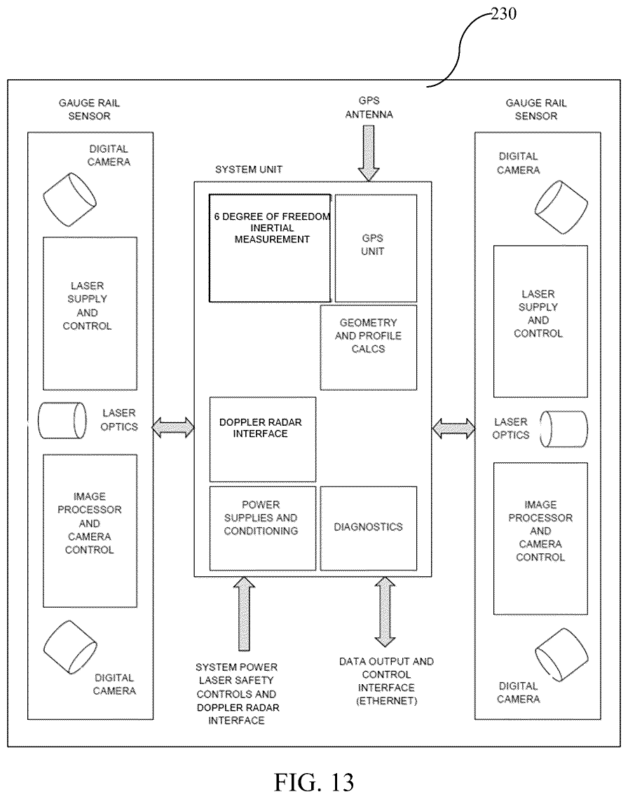

FIG. 13 illustrates an exemplary hardware architecture 230 of the two rail sensor configuration system 200 for measuring and generating data relating to track geometry and rail profile measurement. External inputs to the hardware architecture may include system power, laser safety control, doppler radar, and GPS, for example.

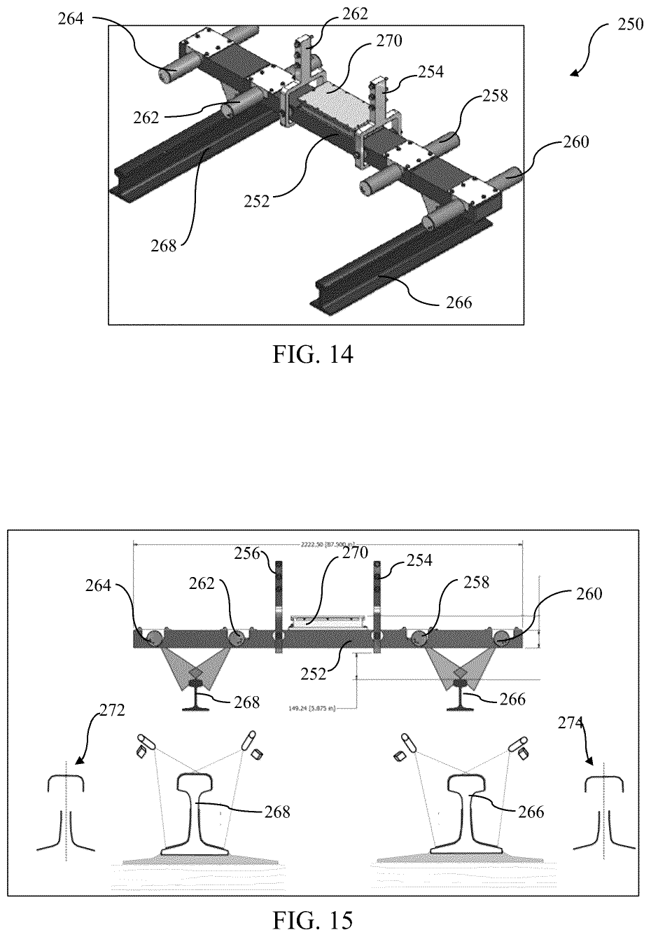

FIGS. 14-16 further illustrates an alternate four-rail sensor configuration system 250 in an embodiment of the present invention. As illustrated, a main beam 252 may be rigidly attached to frame brackets 254, 256 (or a frame in a hi-rail application, described above). A pair of removable and rotational laser optic sensors 258, 260 may extend on one side of the main beam 252 and another pair of removable and rotational laser optic sensors 262, 264 may extend from an opposite side of the main bean 252 for measuring, via lasers and cameras, as described above, the geometries and the surfaces of rails 266, 268, respectively. Specifically, sensors 258, 260 may extend on opposite sides of a first rail 266 and sensors 262, 264 may extend on opposite sides of a second, parallel rail 268. A control box 270 may contain additional sensors, such as inertial sensors including, for example, accelerometers and gyroscopes for additional inertial data.

As illustrated in FIG. 15, the laser-optic sensors 258, 260 may obtain, together, inside and outside profiles of rail track geometry of rail 266, shown by the outline 274, whereas the laser-optic sensors 262, 264 may obtain, generally, inside and outside profiles of rail track geometry of rail 268, shown by the outline 273. Thus, the four rail sensor configuration system 250, as described herein, may provide more detail with respect to the rail surfaces of rails 266, 268 than the two rail sensor configuration system 200, described above.

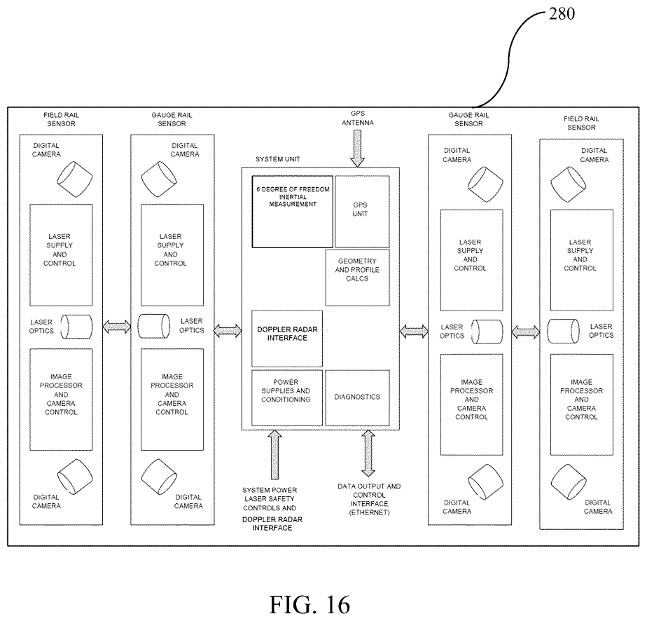

FIG. 16 illustrates an exemplary hardware architecture 280 of the four rail sensor configuration for measuring and generating data relating to track geometry and rail profile measurement. External inputs to the hardware architecture may include system power, laser safety control, doppler radar, and GPS, for example.

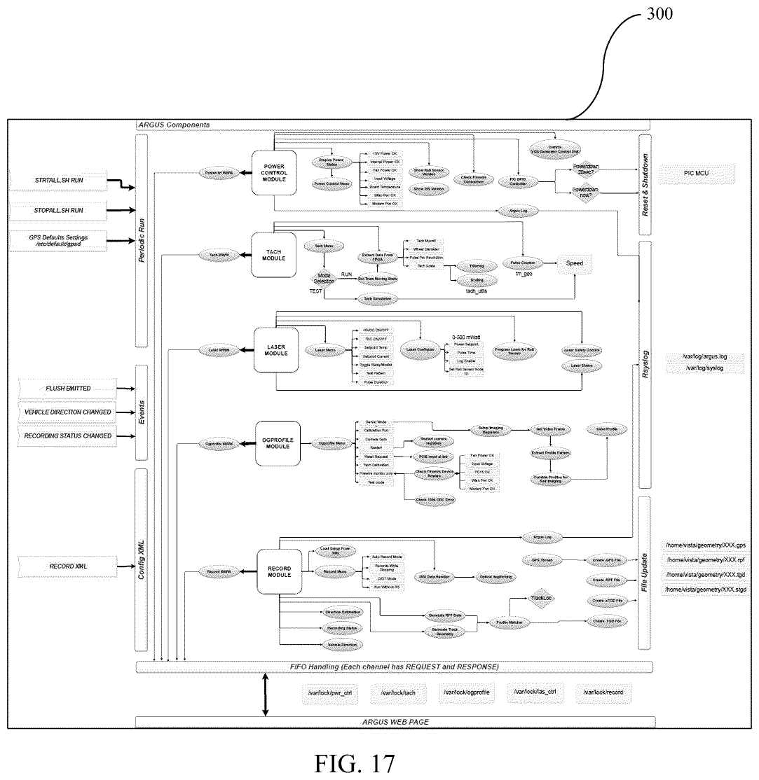

FIG. 17 illustrates an exemplary power and communication panel architecture 300 for either or both of the two rail sensor configuration 200 and/or the four rail sensor configuration 250, in an embodiment of the present invention.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A system of measuring track rail geometry comprising:
a frame comprising one or more track geometry measurement sensors, wherein the frame comprises a rotatable arm and a hitch bar extending from the rotatable arm, wherein the rotatable arm is configured to rotate the frame from a horizontal configuration to a vertical configuration when the high bar extending from the rotatable arm is rigidly held within a hitch receiver tube disposed on a hi-rail vehicle.

2. A system of measuring track rail geometry comprising:
a hanger bracket extending from an L-bracket on an underside of a train locomotive, wherein a track rail measurement system is disposed on the hanger bracket, wherein the track rail measurement system comprises one or more track rail geometry measurement sensors, and further wherein at least one shock spring connects the trail rail measurement system to the hanger bracket.

3. A system for measuring distance or velocity or both distance and velocity of a locomotive or a hi-rail vehicle comprising:
a dual radar module having a first antenna and a second antenna, wherein the first and second antennas are disposed in a V-configuration, wherein the dual radar module is configured to be placed on a locomotive or a hi-rail vehicle in a location near a pair of parallel track rails.
